(19) United States
(12) Patent Application Publication
(10) Pub. No.: US 2004/0140955 A1
(43) Pub. Date: Jul. 22, 2004

(54) Input device for a computer and method of operation

(76) Inventor: Kristofer Erik Metz, Meridian, ID (US)

Correspondence Address: HEWLETT-PACKARD COMPANY, Intellectual Property Administration, P.O. Box 272400, Fort Collins, CO, 80527-2400, US

(21) Appl. No.: 10/348,368

(22) Filed: Jan. 21, 2003

(51) Int. Cl. G09G 5/08

(52) U.S. Cl. 345/166

(57) ABSTRACT

An input device for a computer comprises a housing adapted to fit within a PCMCIA chamber of a computer, the housing having a connector for connecting to a bus accessible within the PCMCIA chamber, a position sensor disposed in the housing; a transmitter disposed in the housing, capable of transmitting position information obtained from the position sensor to the computer; and a rechargeable power source disposed in the housing and operatively connected to the connector, the power source being rechargeable when the housing is disposed within the PCMCIA chamber.

### BACKGROUND OF THE INVENTION

Historically, users of laptop computers or other portable electronic instruments that employ a pointing or other input device, such as a mouse, have had to carry that device separately from the host computer that uses the input device. A computer mouse represents the most common type of input device, and operates to control certain functions of a computer. When the computer mouse is needed, it typically must be physically coupled or connected via a cable (i.e. tethered) into the electronic device to enable use of the mouse. The cable or tether supplies power to the mouse and also communicates signals from the mouse about its position and user commands.

Eliminating the tether which connects the input device (e.g. mouse) to the electronic device (e.g. laptop computer) is often desirable, e.g. to increase the range of movement of the mouse. However, making the input device a wireless device can result in additional problems associated with powering the device.

In addition, most existing portable computers include one or more Personal Computer Memory Card International Association (PCMCIA) slots formed along the base of the computer to allow electrical communication to be established between the computer and external communication systems. PCMCIA guidelines define three types of cards and sockets for support of electronic equipment. PCMCIA standards require all PC cards to have the same length and width (roughly the size of a credit card), and each card includes a connector to allow it to be connected to the computer or other host device. In particular, according to known PCMCIA standards, PC cards have a length of 85.6 mm (3.4 inches), a width of 54.0 mm (2.1 inches), and a height of 3.3 mm (0.1 inches), 5.0 mm (0.2 inches) or 10.5 mm (0.4 inches) depending upon if the card is a Type I card, Type II card or Type III card, respectively. However, as many portable computers include built-in LAN and modem ports, the need for a user to use the PCMCIA slots for such connectivity has been greatly reduced.

### SUMMARY OF THE INVENTION

According to one aspect of the invention, an input device for a computer comprises a housing adapted to fit within a PCMCIA chamber of a computer, the housing having a connector for connecting to a bus accessible within the PCMCIA chamber, a position sensor disposed in the housing, a transmitter disposed in the housing, capable of transmitting position information obtained from the position sensor to the computer, and a rechargeable power source disposed in the housing and operatively connected to the connector, the power source being rechargeable via the bus when the housing is disposed within the PCMCIA chamber.

### BRIEF DESCRIPTION OF THE DRAWINGS

FIG. 1 is a perspective view of a system according to an embodiment of the present invention;

FIG. 2 is a partial perspective view of an exemplary input device according to an embodiment of the present invention;

FIG. 3 is a block diagram of a basic architecture of an exemplary input device according to an embodiment of the present invention; and

FIG. 4 illustrates operation of the system according to an embodiment of the present invention.

### DETAILED DESCRIPTION OF THE PREFERRED EMBODIMENT

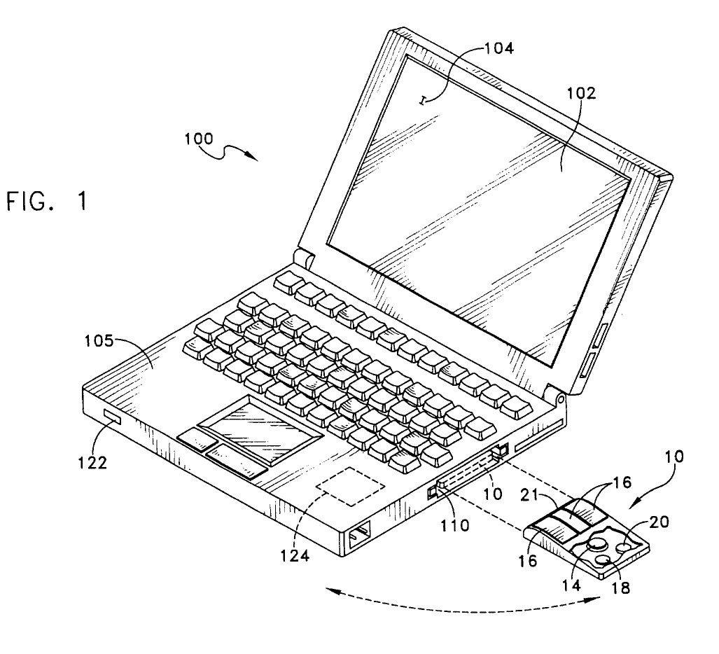

FIG. 1 illustrates an exemplary laptop or notebook host computer 100 comprising a display portion 102 and a base 105 containing a processor (e.g. a CPU), memory, and bus structure (not shown). Base 105 of computer 100 further includes a PCMCIA slot or chamber 110. Electronic input device 10, illustrated as a computer mouse, may be used to provide positional input to computer 100. Communication system 120 such as a wireless telecommunications system, operatively couples electronic input device 10 to computer 100 to enable transfer of positional information from the input device to the host computer for controlling movement of a display reference such as cursor 104.

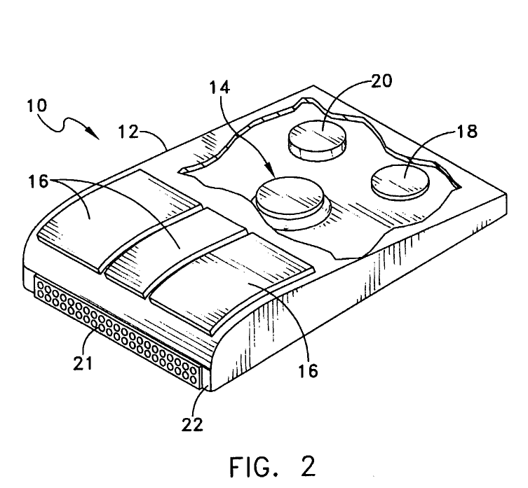

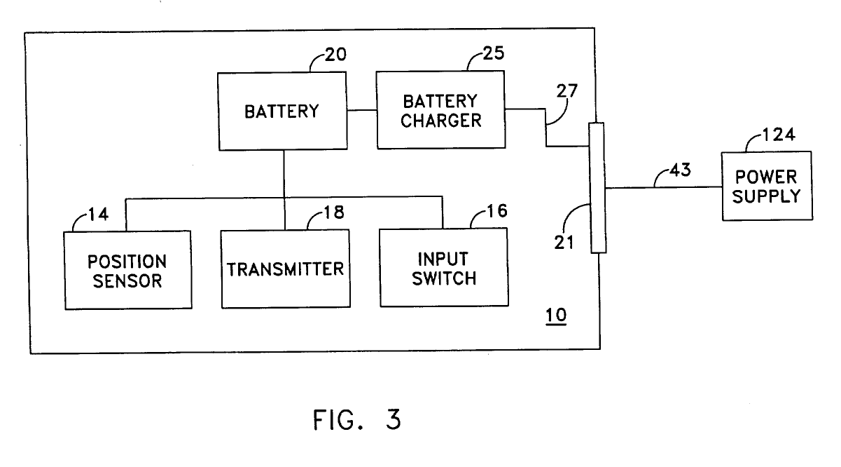

A bus structure 43 (FIG. 3) disposed within base 105 of computer 100 is operatively connected to a power supply 124 for supplying power to the host computer. PCMCIA chamber 110 formed in base 105 is adapted such that the bus 43 is accessible via the chamber 110, e.g. via a socket or pin connection within the chamber. Electronic input device 10 is configured and adapted for being removably stored within chamber 110. In an exemplary embodiment, chamber 110 is a Type III PCMCIA chamber, and electronic device 10 is an optical mouse having dimensions that fit within the PCMCIA Type III form factor so as to be insertable therein (and removable therefrom). Chamber 110 is of sufficient size to accept housing 12 (FIG. 2) of electronic input device 10 and further provide access to power supply 124 via bus 43 for input device 10.

Electronic input device 10 further comprises a rechargeable power source such as rechargeable battery 20. Battery 20 may be used to provide power for electronic and/or optical components in electronic input device 10. Such components include those components used to detect a position of electronic input device 10 relative to a physical space in a predetermined plane and/or to detect a state of an input switch 16 formed on device 10. When the input device 10 is inserted into PCMCIA chamber 110, battery 20 may be recharged from power supply 124 accessible via bus 43 from within chamber 110. In an exemplary embodiment, electronic input device 10 is functionally inoperative while stored within chamber 110. That is, while stowed within the PCMCIA chamber 110, input device 10 does not operate to transfer data information such as position data to the computer 100 for processing and display, but rather is re-charged via the power from the computer's power supply 124, and carried by bus 43 (FIG. 3) to battery 20 of input device 10.

Input device 10 includes a transmitter 18 for communicating positional input data from electronic input device 10 to computer 100. For example, communication with computer 100 may be accomplished via wireless communication system 120 such as an Infrared Data Association (IrDA) type transmitter, a BLUETOOTH™ transmitter, an IEEE 802.11b transmitter, and the like to a correspondingly configured receiver 122 within computer 100.

FIG. 2 shows an exemplary electronic input device 10 comprising housing 12 of a size sufficient to enable insertion within PCMCIA chamber 110 (FIG. 1) of computer 100 (FIG. 1). Electronic input device 10 is a wireless device and may comprise a mouse or other pointing device, joystick, touch pad, and the like, or a combination thereof. Input device 10 further includes position sensor 14, transmitter 18, and battery 20 disposed in housing 12. Input switch 16, useful for providing selective user input to computer 100, is disposed on a top portion housing 12 as shown in FIG. 2, but in general, may be positioned anywhere about housing 12 to accommodate user preferences and ergonomic configuration of the device. Housing 12 may have a substantially ergonomic shape adapted to fit within or conform to the hand of a user, as well as to removably fit within chamber 110 (FIG. 1). Housing 12 further includes contacts 21 disposed on a portion of the input device 10 and adapted to engage a corresponding socket connection within the PCMCIA chamber 110 in electrical communication with power supply 124 (FIG. 1). Housing 12 may have a length such that input device 10 is entirely (or at least partially) contained within chamber 110 (FIG. 1). When inserted within chamber 110, contacts 21 matingly engage the PCMCIA socket to which the bus 43 (FIG. 3) is connected to provide an electrical interface or pathway for obtaining power from computer 100. In this manner, battery 20 may obtain power from power supply 124 to recharge battery 20. While in an exemplary embodiment contacts 21 are disposed at a first end 22 of housing 12 for insertion into PCMCIA chamber 110, contacts may also be disposed along one or more sides of the housing 12 (e.g. contact rails) for corresponding electrical contact with the bus interface to enable electrical communication with the host computer power supply 124 in FIG. 1.

In an exemplary embodiment, input device 10 comprises an optical mouse, with position sensor 14 configured as an optical sensor capable of detecting a position of the mouse relative to a predetermined plane such as a surface on which device 10 is movably disposed. Transmitter 18 may include a light emitting diode (LED) capable of transmitting position information obtained from position sensor 14, e.g. movement of the device in a predetermined plane. Transmitter 18 may also be capable of transmitting state information from input switch 16, e.g. if input switch 16 is in a “closed” or “open” state or, if input switch 16 comprises a wheel, a direction of turning and a number of turns of the wheel. In a preferred embodiment, transmitter 18 may be a wireless transmitter such as an IrDA transmitter, a BLUETOOTH™ transmitter, or an IEEE 802.11b transmitter, or the like.

Input switch 16 may be used for user input other than relative position, e.g. state assignments associated with an activatable member. Input switch 16 may be a set of contacts, a button, a wheel, a sphere, a joystick, a pressure sensitive surface, or the like, or a combination thereof. Further, a plurality of input switches 16 may be present, e.g. two buttons and a wheel. Note that when input device 10 is disposed within PCMCIA chamber 110 (FIG. 1), input device 10 is unable to function as a pointing or data input device for the host computer 100 (FIG. 1) (i.e. input device 10 is functionally inoperative). More particularly, position sensor 14 is functionally inoperative when housing 12 is disposed within chamber 110, as is input switch 16 and transmitter 18. Note further that, while position sensor 14 has been described as an optical sensor, sensor 14 may alternatively comprise a wheel, a sphere such as a trackball or mouse ball, a joystick, a pressure sensitive surface, and the like, or a combination thereof.

Battery 20 operates to provide power to elements of electronic input device 10 requiring power such as circuitry comprising transmitter 18, position sensor 14, input switch 16 or associated signal processing circuitry (not shown). FIG. 3 is an exemplary block diagram of the basic architecture according to an embodiment of the invention. Interface 21 connects input device 10 to bus 43 accessible via PCMCIA chamber 110 (FIG. 1) and in electrical communication with host power supply 124. A battery charger 25 connected to battery 20 and coupled to connector interface 21 via lead 27 enables battery 20 to be recharged when housing 12 is inserted within chamber 110 within the host computer 100.

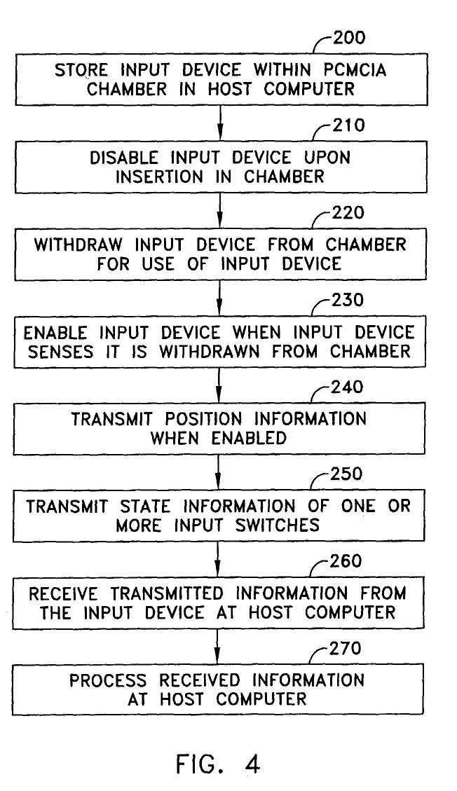

In the operation of an exemplary embodiment, referring additionally to FIG. 4, a user initially stores electronic input device 10 (FIG. 1) within PCMCIA chamber 110 (FIG. 1) (step 200). Upon insertion into PCMCIA chamber 110, input device 10 is disabled such that the device no longer operates to transfer data information to the host computer for processing and display (step 210). When electronic input device 10 is seated within chamber 110, power from the host computer's power supply 124 (FIG. 1) is carried by bus 43 (FIG. 3) through connector 21 (FIG. 2) for recharging battery 20.

When a user wishes to utilize input device 10, the user withdraws electronic input device 10 (FIG. 1) from PCMCIA chamber 110 (FIG. 1). This may be accomplished via standard ejection techniques available with PCMCIA chamber 110, e.g. by using push pins or levers (not shown in the figures) which may be accessible on an outside of base 105 (FIG. 1) proximate chamber 110 (step 220). Upon withdrawal, electronic input device 10 may sense its ejection from chamber 110 and become enabled (step 230) such that position information obtained from optical position sensor 14 (FIG. 2) is transmitted to the host computer 100 (FIG. 1) via transmitter 18 (FIG. 2) (step 240). Such sensing may occur when electronic circuitry in housing 12 detects the removal of contacts 21 (FIG. 2) from the PCMCIA socket and bus, (e.g. absence of power or an open condition of two or more contacts).

When electronic device 10 (FIG. 1) is operable, state information of one or more input switches 16 (FIG. 2) may also be transmitted (step 250). A correspondingly configured receiver 122 (FIG. 1) may receive and pass the information transmitted from electronic input device 10 to computer 100 (FIG. 1) such as via driver software in operative communication with communication system 120 (step 260). Computer 100 (FIG. 1) may analyze the received information and make the analyzed received information available for use by other software, e.g. application software (step 270) for processing and display.

It will be understood that various changes in the details, materials, and arrangements of the parts which have been described and illustrated above in order to explain the nature of this invention may be made by those skilled in the art without departing from the principle and scope of the invention as recited in the following claims.

What is claimed is:

1. An input device for a computer, comprising:
a housing adapted to fit within a PCMCIA chamber of a computer, the housing having a connector for connecting to a bus accessible within the PCMCIA chamber;
a position sensor disposed in the housing;
a transmitter disposed in the housing, capable of transmitting information to the computer including position information obtained from the position sensor; and
a power source disposed in the housing and operatively connected to the connector, the power source being rechargeable via the bus when the housing is disposed within the PCMCIA chamber.

2. The input device according to claim 1, wherein the housing is adapted to fit entirely within the PCMCIA chamber.

3. The input device according to claim 1 wherein the input device is a wireless computer mouse.

4. The input device according to claim 1, wherein the input device is an optical computer mouse.

5. The input device according to claim 1, wherein the position sensor comprises at least one of (i) an optical position sensor, (ii) a wheel, (iii) a sphere, (iv) a pressure sensitive surface, and (v) a joystick.

6. The input device according to claim 1, wherein the PCMCIA chamber is a Type III PCMCIA chamber.

7. The input device according to claim 1, wherein the transmitter comprises at least one of an (i) IrDA transmitter, (ii) a BLUETOOTH transmitter, and (iii) an IEEE 802.11b transmitter.

8. The input device according to claim 1, further comprising an input switch, disposed in the housing, the input switch being functionally operable only when the housing is removed from the PCMCIA chamber, and wherein information transmitted from the transmitter comprises at least one of (i) position information obtained from the position sensor and (ii) state information of the input switch.

9. The input device according to claim 8, wherein the input switch comprises at least one of (i) a set of contacts, (ii) a button, (iii) a wheel, (iv) a sphere, and (v) a pressure sensitive surface.

10. A computer system, comprising:
a general-purpose computer comprising a base, a processor, memory, and a bus;
a PCMCIA chamber formed in the base through which a portion of the bus is accessible; and
an input device for providing positional input to the computer, the input device configured for being storable within the PCMCIA chamber, the input device functionally inoperative while stored within the PCMCIA chamber, the input device further comprising a rechargeable power source that is rechargeable from another power source accessible via the portion of the bus when the input device is inserted within the PCMCIA chamber.

11. A computer system according to claim 10, wherein the PCMCIA chamber comprises a Type III PCMCIA chamber.

12. A computer system according to claim 10, wherein the input device comprises:
a wireless transmitter for transmitting positional input to the computer;
an optical position sensor; and
a user manipulatable input switch, and wherein the transmitter is operative to transmit a state of the user manipulatable input switch to the computer.

13. A computer system according to claim 12, wherein the wireless transmitter comprises at least one of an (i) IrDA transmitter, (ii) a BLUETOOTH transmitter, and (iii) an IEEE 802.11b transmitter.

14. A method for operating an input device storable within a PCMCIA chamber of a computer, comprising:
generating a signal based on a sensed movement of an input device for controlling movement of a display reference of a computer;
disabling generation of the signal upon insertion of the input device within a PCMCIA chamber of the computer; and
establishing a power pathway from a power source within the computer to a rechargeable power source of the input device for charging the rechargeable power source upon insertion of the input device within the PCMCIA chamber.

15. The method of claim 14, wherein the PCMCIA chamber is a Type III PCMCIA chamber.

16. The method of claim 14, wherein the input device is an optical mouse.

17. The method of claim 14, wherein the entire input device is inserted into the PCMCIA chamber.

18. A computer system comprising:
a portable computer comprising a base, a processor, a power source, a display, memory, and a bus connected to the power source, the portable computer having a Type III PCMCIA chamber formed in the base and operatively coupled to a portion of the bus;
a wireless pointing apparatus for providing position data to the portable computer for controlling movement of a display reference of the computer, the pointing apparatus comprising:
a housing adapted to fit within the Type III PCMCIA chamber of the computer, the housing having a connector for connecting to the bus accessible within the Type III PCMCIA chamber when the housing is inserted within the Type III PCMCIA chamber;
a position sensor disposed in the housing for generating position data to be conveyed to the portable computer when the housing is not inserted within the Type III PCMCIA chamber;
a transmitter disposed in the housing for wirelessly transmitting position information obtained from the position sensor to the computer; and
a rechargeable power source disposed in the housing and operatively connected to the connector, the power source being rechargeable via the computer power source connected to the bus when the housing is inserted within the Type III PCMCIA chamber.

19. The system according to claim 18, wherein the wireless pointing apparatus is an optical mouse.

20. The system according to claim 18, wherein the housing defines an ergonomically shaped mouse.

21. An input device for a computer, comprising:
a housing adapted to fit within a PCMCIA chamber of a computer, the housing having first means for connecting to a bus accessible within the PCMCIA chamber;
second means disposed in the housing for sensing a position of said input device;
third means disposed in the housing for transmitting information to the computer including position information obtained from the second means for sensing; and
fourth means disposed in the housing for providing a source of power to said input device, the fourth means operatively coupled to the first means for connecting and rechargeable via the bus when the housing is disposed within the PCMCIA chamber.

22. The input device according to claim 21, further comprising means disposed in the housing for selectively providing user input to said input device.

23. The input device according to claim 22, wherein the means for selectively providing user input is functionally operable only when the housing is removed from the PCMCIA chamber, and wherein information transmitted from the third means for transmitting comprises at least one of (i) position information obtained from the second means for sensing and (ii) user input information.

24. The input device according to claim 21, wherein the housing is adapted to fit entirely within the PCMCIA chamber.

25. The input device according to claim 21 wherein the input device is a wireless computer mouse.

26. The input device according to claim 21, wherein the input device is an optical computer mouse.

27. The input device according to claim 21, wherein the PCMCIA chamber is a Type III PCMCIA chamber.
